(19) United States
(12) Patent Application Publication
(10) Pub. No.: US 2004/0247053 A1
(43) Pub. Date: Dec. 9, 2004

(54) Method for detecting a signal and receiver system for the implementation of the method

(75) Inventors: Nidham Ben Rached, Paris (FR); Thierry Lucidarme, Montigny-Le-Bretonneux (FR)

Correspondence Address: Michael L. Kenaga, PIPER RUDNICK LLP, P.O. Box 64807, Chicago, IL, 60664-0807, US

(73) Assignee: NORTEL NETWORKS LIMITED

(21) Appl. No.: 10/719,776

(22) Filed: Nov. 21, 2003

(30) Foreign Application Priority Data
Dec. 4, 2002 (FR) 02 15272

(51) Int. Cl. H04L 27/06

(52) U.S. Cl. 375/340

(57) ABSTRACT

The method seeks detection of a signal burst transmitted on the initiative of a sender on a radio channel listened to by a receiver system. The burst transmitted represents a predetermined digital sequence. Channel parameters representing a statistical behaviour of the radio channel are estimated and a detection magnitude is evaluated on the basis of the estimated channel parameters and of a correlation between a signal received at the receiver system and the predetermined digital sequence. The detection magnitude is compared with an adaptive detection threshold to decide whether the signal burst is detected.

### BACKGROUND OF THE INVENTION

The present invention relates to the detection, by a receiver, of signal bursts transmitted on a radio channel in a communication system.

It finds an application in particular in the detection of short bursts sent in a radiocommunication network. These bursts may be of various types, such as initial-synchronization bursts or bursts of random access to the mobile network. The latter case will be more particularly developed hereinbelow, without this being limiting.

When a mobile terminal of a communication network wishes to avail itself of communication resources, for example to make a call, it executes a request to the network that manages and distributes the resources. This random access request generally consists in the transmission of a message whose preamble is a signal burst representing a predetermined digital sequence. This message is sent on an up radio channel listened to by a reception system of the network. In radiocommunication systems such as GSM (“Global System for Mobile communications”) and UMTS (“Universal Mobile Telecommunication System”), this channel is called RACH or PRACH (“Packet Random Access Channel”). The format of such a message is in particular described in section 5.2.2.2 of the TS 25.211 technical specification version 5.2.0 Release 5, “Physical channels and mapping of transport channels onto physical channels (FDD)”, published in September 2002 by the 3GPP organization. Reliable detection of random access bursts on the RACH is important since the communications setup failure rate seen by a mobile radio user depends directly thereon.

An improvement in the reliability of detection is particularly beneficial in respect of reception systems that comprise sectorial or omnidirectional smart antennas.

In the UMTS system, the predetermined digital sequence sent on the RACH channel by a mobile terminal has a size of 4096 “chips”, a chip being an element of code in accordance with the coding used in the system. The data exchanged consist of 10 ms frames, themselves subdivided into 15 time intervals (or “slots”) of 666 μs, corresponding to 2560 chips. Thus, the signal burst associated with the digital sequence sent on the RACH is received within an interval corresponding to two consecutive slots.

When the radio network wishes to determine whether a random access burst has been transmitted on an RACH channel, it calculates for the 1024 (=2 ×2560 −4096) possible positions of the digital sequence of the burst within two consecutive slots, a correlation between the sequence as detected and the predetermined digital sequence which is known to the network.

A criterion must be defined to decide, on the basis of such a correlation, whether the predetermined digital sequence is present. This criterion is customarily based on the correlation's energy level which is compared with a predefined threshold level. However, depending on the propagation conditions of the radio channel used, the signal received by the radio network is attenuated to a greater or lesser extent. It follows that the fixing of the threshold is tricky: too low a threshold gives rise to numerous false detections that disturb the system, whereas too high a threshold causes access requests originating from terminals relatively far from the base station to be missed.

A power ramp can be used by the mobile terminal to regularly retransmit the burst for access to the network on the RACH channel, with increased transmission power for each new transmission, for as long as the network has not responded to its request for resources. This method makes it possible to improve the detection of the burst by the radio network, in particular in the case where the low transmission power of the first transmissions is the reason for the absence of detection of the burst on the RACH.

However, through the repetition of the random access burst on the RACH, this method occupies the channel to the detriment of any requests from the other users. Furthermore, the high power of the signals thus repeated may create nuisance interference in the system.

An object of the present invention is to propose a method for detecting predefined signals which makes it possible to attenuate the drawbacks of the known methods.

### SUMMARY OF THE INVENTION

The invention thus proposes a method for detecting a signal burst transmitted on the initiative of a sender on a radio channel listened to by a receiver system, the transmitted burst representing a predetermined digital sequence, in which method channel parameters representing a statistical behaviour of the radio channel are estimated and a detection magnitude is evaluated on the basis of the estimated channel parameters and of a correlation between a signal received at the receiver system and the predetermined digital sequence. According to the invention, the detection magnitude is compared with an adaptive detection threshold to decide whether the signal burst is detected.

The reliability of the detection is thus increased by virtue of a posteriori consideration of the effects of this detection. Feedback then allows a relevant adaptation of the detection threshold employed.

The invention also proposes a receiver system adapted to the implementation of the above method.

### BRIEF DESCRIPTION OF THE DRAWINGS

FIG. 1 is a diagram of a system implementing the invention;

FIG. 2 is a schematic showing the main signalling exchanges with a view to allocating resources to a mobile terminal in a GSM type system; and

FIG. 3 is a flowchart showing certain steps of the method according to the invention.

### DESCRIPTION OF PREFERRED EMBODIMENTS

Dealt with hereinbelow is the nonlimiting case of an embodiment of the invention applied to the detection of a signal burst of random access to a cellular radio network.

The mobile terminal 1 sends a signal burst over a RACH type channel when it wishes to access the network and obtain communication resources therefrom.

The network is composed mainly of a network core providing for the switching of the data and the connection to other communication networks, such as the PSTN (“Public Switched Telephone Network”), and of a radio network responsible for the exchanges of data and of signalling with mobile terminals.

The radio network generally comprises send and receive systems, belonging to base stations, as well as base station controllers providing for the functions of higher level than the simple transmission of the data, such as the management of radio resources or of mobility for example. Certain functions may be executed either by the base stations or by the base station controllers. Certain of them may also be performed in a shared manner by these entities.

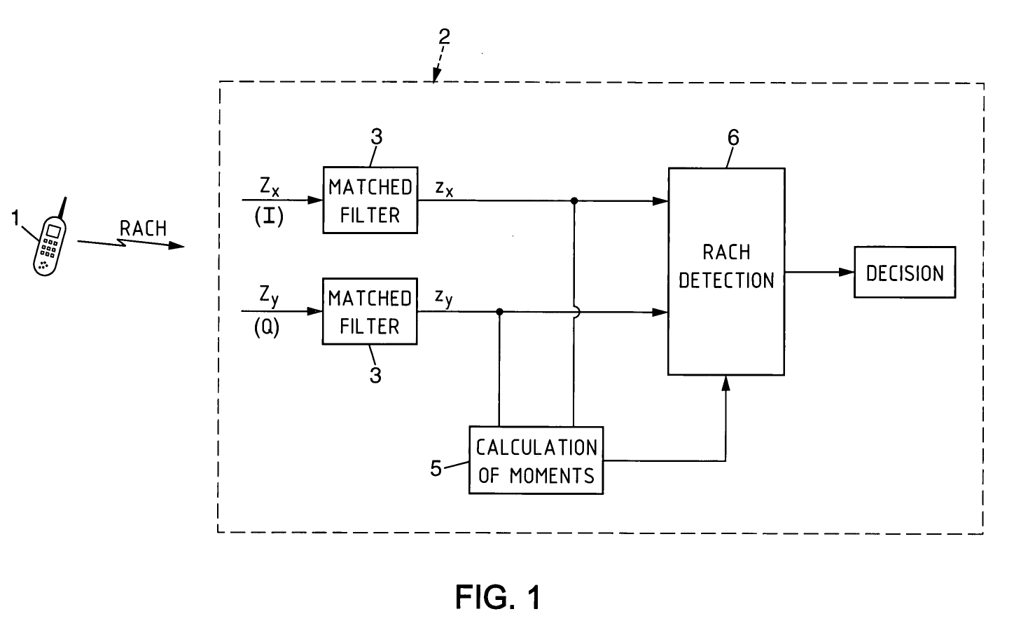

We consider a base station including a reception system 2 capable of receiving signals sent in particular by the terminal 1. In an advantageous but non-restrictive manner, certain of the functions performed by the reception system 2, which will be detailed hereinbelow, are the responsibility of the controller on which this base station depends. This controller 3 is called the BSC (“Base Station Controller”) in the terminology used in the GSM system. In the UMTS system, the base station is sometimes dubbed “node B” and the base station controller is called the RNC (“Radio Network Controller”). The reception system 2 illustrated in FIG. 1 comprises two main reception paths, in-phase (I) and quadrature (Q). The radio signal received is mixed with two quadrature radio waves at the carrier frequency. After low-pass filtering, the two components resulting therefrom form an in-phase signal Zₓ and a quadrature signal Z_{y} respectively which, together, may be seen as constituting a complex signal Z=Zₓ+j.Z_{y}.

The signal Z comprises the signals possibly sent by the mobile terminal 1 and also the residual signals consisting of noise and of interference. Given that the carrier frequencies are generally shared by several users, the signals transmitted by other mobile terminals constitute interference, similar to the noise in a CDMA system such as UMTS. At each instant the system 2 therefore receives signals Zₓ, Z_{y} consisting of digital sequences on each of the two paths I and Q.

The predetermined digital sequence represented by the random access burst is a sequence s of M samples (chips in a CDMA system) having a sufficient length to ensure detection under good conditions. In the case of UMTS, it is M=4096 chips, i.e. slightly more than a millisecond (the chip rate is 3.84 Mchip/s). To detect the possible presence of such a burst, the receiver system comprises two filters 3, respectively on the I and Q paths, which are matched to the predetermined sequence of chips, and which carry out the operation z=Z.s★, where (.)★ denotes the complex conjugate. The complex signal z=zₓ+j.z_{y} produced by these filters 3 thus represents a correlation between the signal received and the sequence to be detected, calculated at the chip frequency. The two real signals zₓ and z_{y}, correspond respectively to the real and imaginary components of the signal detected after matched filtering.

Having detected the complex signal z=zₓ+jz_{y}, the receiver system 2 performs a calculation to determine the likelihood according to which this signal z reveals the presence of the known digital sequence sent on the RACH by the mobile terminal 1.

Let H1 be the hypothesis according to which the random access burst was sent on the RACH channel and H0 the complementary hypothesis according to which only noise is present. The ratio of the probabilities based on knowing the detected signal z may be written as follows, according to Bayes' formula:

P(H1/z)/P(H0/z)=(P(z/H1)/P(z/H0))×(P(H1)/P(H0)) (1)

where P(a/b) denotes the probability of a knowing b.

The receiver system 2 regards the burst as having been sent on the RACH if this ratio P(H1/z)/P(H0/z) is greater than a certain threshold c. Furthermore, the ratio

$$\frac{P ( H1 )}{P ( H0 )} = \frac{P ( H1 )}{1 - P ( H1 )}$$

is independent of the signal detected. The ratio P(H1/z)/P(H0/z) can be regarded as greater than the detection threshold c, if the ratio P(z/H1)/P(z/H0) is greater than a threshold c′, such that c′=c×P(H0)/P(H1).

The receiver system 2 therefore evaluates the ratio of probabilities P(z/H1)/P(z/H0) to decide, by comparison with a threshold, whether a random access burst has or has not been detected on the RACH channel. This evaluation advantageously considers the propagation conditions on this channel.

The signal detected by the receiver system 2 subsequent to the sending of a burst may be written in the form Z=a.s+n, where a denotes the attenuation or gain of the propagation channel and n denotes the Gaussian white noise picked up by the system 2.

At the output of the filters 3 matched to the sequence s, the signal may then be written z=a.|s|²+n′, where n′=n.s★ also has the properties of Gaussian noise. Without affecting generality, the sequences s may be regarded as normed, i.e. |s|²=1.

The probability of detecting the signal z after matched filtering given that the predefined sequence was sent on the RACH can then be written:

$$P ( z / H1 ) = \frac{1}{\sqrt{π {N}_{0}}} \cdot {\int }_{C} {ⅇ}^{- \frac{1}{{N}_{0}} \cdot {\vert z - a \vert}^{2}} \cdot p ( a ) \cdot ⅆ a ,$$

with C the set of possible realizations of the complex gain a on the propagation channel, No the power of the noise and p(a) the probability density of the gain a. Likewise, the probability of detecting the signal z after matched filtering given that noise alone was received can be written:

$$P ( z / H0 ) = \frac{1}{\sqrt{π {N}_{0}}} \cdot {ⅇ}^{- \frac{1}{{N}_{0}} \cdot {\vert z \vert}^{2}} .$$

From this we deduce the relation:

$$\frac{P ( z / H1 )}{P ( z / H0 )} = {\int }_{C} {ⅇ}^{- \frac{1}{{N}_{0}} \cdot ( {\vert a \vert}^{2} - 2 \cdot Re ( {za}^{*} ) )} \cdot p ( a ) \cdot ⅆ a \qquad ( 2 )$$

If the signal z is expanded according to its two components for each of the two paths, we have z=zₓ+j z_{y}. Likewise, the gain of the propagation channel a can be written in the form: a=aₓ+j a_{y}. The independence of the two random variables aₓ and a_{y} makes it possible to factorize the probability density p(a) into the form: pₓ(aₓ).p_{y}(a_{y}) and to write:

$$\begin{matrix}\frac{P ( z / H1 )}{P ( z / H0 )} = {\int }_{C} {ⅇ}^{- \frac{1}{{N}_{0}} \cdot ( {a}_{x}^{2} + {a}_{y}^{2} - 2 ( {z}_{x} {a}_{x} + {z}_{y} {a}_{y} ) )} \cdot {p}_{x} ( {a}_{x} ) {p}_{y} ( {a}_{y} ) \cdot ⅆ {a}_{x} ⅆ {a}_{y} \\ = ( {\int }_{R} {ⅇ}^{- \frac{1}{{N}_{0}} \cdot ( {a}_{x}^{2} - 2 {z}_{x} {a}_{x} )} \cdot {p}_{x} ( {a}_{x} ) \cdot ⅆ {a}_{x} ) \cdot \\ ( {\int }_{R} {ⅇ}^{- \frac{1}{{N}_{0}} \cdot ( {a}_{y}^{2} - 2 {z}_{y} {a}_{y} )} \cdot {p}_{y} ( {a}_{y} ) \cdot ⅆ {a}_{y} )\end{matrix} \qquad ( 3 )$$

where R denotes the set of real numbers.

Moreover, the Hermite polynomials are polynomials of order n, n being a natural integer, which satisfy the following differential equation: −Hₙ″(x)+2x.Hₙ′(x). The first few Hermite polynomials, for orders going from 0 to 5 are the following:

H₀(x)=1;

H₁(x)=2x;

H₂(x)=4x²−2;

H₃(x)=8x³−12x;

H₄(x)=16x⁴−48x²+12;

H₅(x)32x⁵−160x³+120x.

These polynomials satisfy the equation:

$${ⅇ}^{2 uv - {u}^{2}} = {\sum }_{n = 0}^{∞} {H}_{n} ( v ) \cdot \frac{{u}^{n}}{n !} ,$$

so that we may write:

$$\begin{matrix}{\int }_{R} {ⅇ}^{- \frac{1}{{N}_{0}} \cdot ( {a}_{x}^{2} - 2 {z}_{x} {a}_{x} )} \cdot {p}_{x} ( {a}_{x} ) \cdot ⅆ {a}_{x} = {\int }_{R} ( {\sum }_{n = 0}^{∞} \frac{1}{n !} \cdot {H}_{n} ( \frac{{z}_{x}}{\sqrt{{N}_{0}}} ) \cdot {( \frac{{a}_{x}}{\sqrt{{N}_{0}}} )}^{n} ) \cdot \\ {p}_{x} ( {a}_{x} ) \cdot ⅆ {a}_{x} \\ = {\sum }_{n = 0}^{∞} \frac{1}{n ! {( \sqrt{{N}_{0}} )}^{n}} \cdot {H}_{n} ( \frac{{z}_{x}}{\sqrt{{N}_{0}}} ) \cdot m {a}_{x , n}\end{matrix}$$

$$\text{with} m {a}_{x , n} = {\int }_{R} {a}_{x}^{n} \cdot {p}_{x} ( {a}_{x} ) \cdot ⅆ {a}_{x}$$

representing the moment of order n of the distribution of the in-phase component of the gain of the propagation channel. Likewise:

$${\int }_{R} {ⅇ}^{- \frac{1}{{N}_{0}} \cdot ( {a}_{y}^{2} - 2 {z}_{y} {a}_{y} )} \cdot {p}_{y} ( {a}_{y} ) \cdot ⅆ {a}_{y} = {\sum }_{n = 0}^{∞} \frac{1}{n ! {( \sqrt{{N}_{0}} )}^{n}} \cdot {H}_{n} ( \frac{{z}_{y}}{\sqrt{{N}_{0}}} ) \cdot m {a}_{y , n} , \\ \text{with} m {a}_{y , n} = {\int }_{R} {a}_{y}^{n} \cdot {p}_{y} ( {a}_{y} ) \cdot ⅆ {a}_{y}$$

representing the moment of order n of the distribution of the quadrature component of the gain of the propagation channel.

Consequently, the probability ratio P(z/H1)/P(z/H0) may be written:

$$\frac{P ( z / H1 )}{P ( z / H0 )} = ( {\sum }_{n = 0}^{∞} \frac{1}{n ! {( \sqrt{{N}_{0}} )}^{n}} \cdot {H}_{n} ( \frac{{z}_{x}}{\sqrt{{N}_{0}}} ) \cdot m {a}_{x , n} ) \cdot ( {\sum }_{n = 0}^{∞} \frac{1}{n ! {( \sqrt{{N}_{0}} )}^{n}} \cdot {H}_{n} ( \frac{{z}_{y}}{\sqrt{{N}_{0}}} ) \cdot m {a}_{y , n} ) \qquad ( 4 )$$

According to the invention, a calculation module 5 of the receiver system 2 estimates the moments ma_{x,n} and ma_{y,n} at the output of the matched filters 3 for each of the two reception paths respectively.

This evaluation is performed over a time interval referred to as the evaluation interval and which corresponds to a smaller number of chips than the number of possible positionings of the random access burst inside two consecutive slots. Returning to the case of UMTS, where there are 1024 possible positions of the burst inside two consecutive slots, it is possible to choose for example an evaluation interval corresponding to 32 chips.

The evaluation of the moments then consists in estimating the probability pₓ(aₓ), p_{y}(a_{y}) of finding each value of a component characteristic of the gain of the propagation channel aₓₙ and a_{y,n}, in the corresponding sample of the signal detected in the evaluation interval. These probabilities are then weighted by the n^{th} power of the associated component value, before being summed, as is indicated by the formulae

$$m {a}_{x , n} = {\int }_{R} {a}_{x}^{n} \cdot {p}_{x} ( {a}_{x} ) \cdot ⅆ {a}_{x} \text{and} m {a}_{y , n} = {\int }_{R} {a}_{y}^{n} \cdot {p}_{y} ( {a}_{y} ) \cdot ⅆ {a}_{y}$$

respectively.

After each new evaluation, the module 5 for calculating the moments sends the result of its calculation to a module 6 for detecting the RACH of the receiver system 2. This module calculates the probability ratio P(z/H1)/P(z/H0) by virtue of formula (4), truncating the summation to an order k<∞:

$$\frac{P ( z / H1 )}{P ( z / H0 )} = ( {\sum }_{n = 0}^{k} \frac{1}{n ! {( \sqrt{{N}_{0}} )}^{n}} \cdot {H}_{n} ( \frac{{z}_{x}}{\sqrt{{N}_{0}}} ) \cdot m {a}_{x , n} ) \cdot ( {\sum }_{n = 0}^{k} \frac{1}{n ! {( \sqrt{{N}_{0}} )}^{n}} \cdot {H}_{n} ( \frac{{z}_{y}}{\sqrt{{N}_{0}}} ) \cdot m {a}_{y , n}$$

This calculation is straightforward since the moments ma_{x,n} and ma_{y,n} have been provided by the module 5. The variance N₀ of the noise is conventionally available in the receiver, on the basis of an average of the energy of the complex signal at the output of the matched filters 3.

It is particularly advantageous for the number k to be greater than 2, so as to consider the moments of high order that finely convey the behaviour of the channel. It could also be limited to 2, in which case the calculation of the ratio P(z/H1)/P(z/H0) can be reduced to that of the energy of the output signal z from the matched filters 3.

The detection module 6 can store tables giving for certain typical values, the corresponding value for the Hermite polynomials. This enables the value of the ratio P(z/H1)/P(z/H0) to be easily determined for any new detected value of zₓ and z_{y} inside the moments evaluation interval.

The probability ratio thus estimated is then compared by the detection module 6 with a detection threshold c′ for example fixed according to an RACH detection reliability objective. If the ratio P(z/H1)/P(z/H0) is greater than c′ (this corresponding to the fact that the ratio P(H1/z)/P(H0/z) itself exceeds a certain threshold as was seen above), the receiver system 2 then regards the predefined sequence as having been sent on the RACH channel. It will thus be possible for resources to be made available to the requester terminal.

In the converse case, where the ratio P(z/H1)/P(z/H0) is less than c′, the reception system 2 may decide to conclude that no sequence has been sent on the RACH channel.

Of course, in the case where the decision of the receiver system 2 is erroneous, for example if it ignores a request sent by the terminal 1 on the RACH, the terminal, which does not receive the expected response, can apply a method of repetition to improve the reliability of detection by the receiver system 2, for example by implementing a power ramp.

Whatever the detection magnitude calculated as a function of the instantaneous signal received, the invention provides for adaptation of the detection threshold with which this magnitude is compared. The adaptation takes into consideration at least one of the following two elements:

objective of a certain false detection rate for the burst, which rate can vary with the radio environment if the same threshold value is kept;

the probability ratio

$$\frac{P ( H1 )}{P ( H0 )} = \frac{P ( H1 )}{1 - P ( H1 )}$$

coming into expression (1) hereinabove.

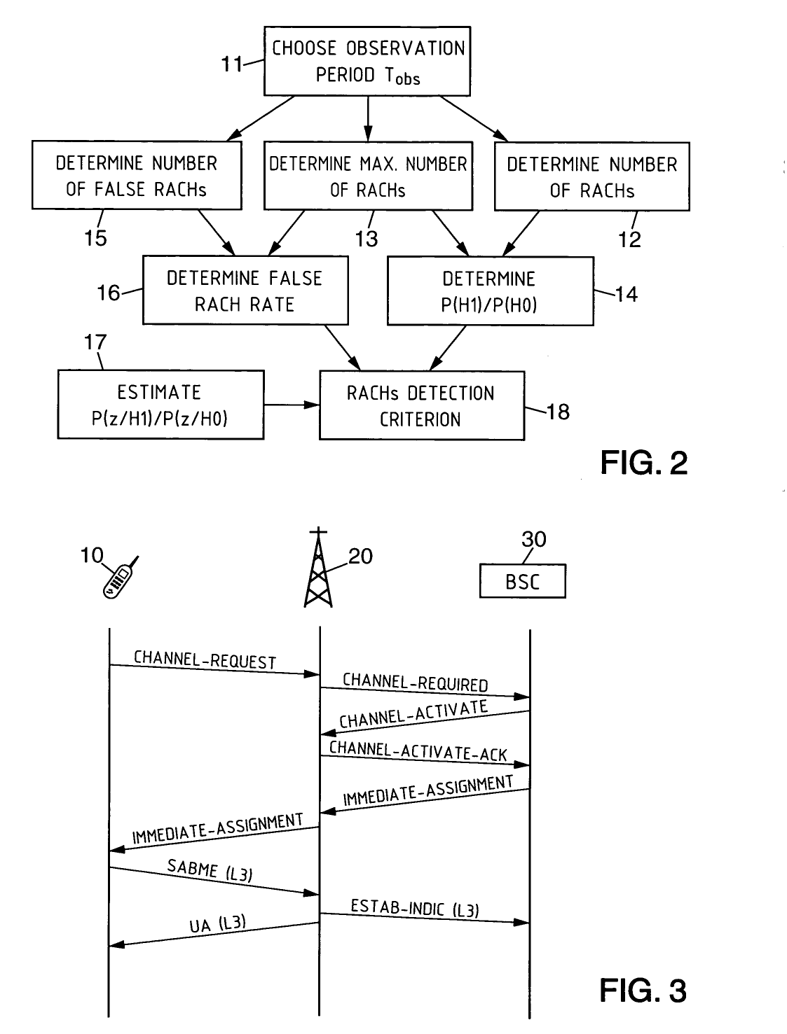

According to an aspect of the invention, the ratio P(H1)/P(H0) forms the subject of an evaluation, updated over time. As is illustrated in FIG. 2, we begin in step 11 by determining an observation period T_{obs}, during which certain indicators will be estimated. This period must be long enough to obtain a significant estimation of the indicators, while permitting sufficiently regular reupdating of the estimations. For example, T_{obs} can be fixed at 30 minutes.

The evaluation of the ratio

$$\frac{P ( H1 )}{P ( H0 )} = \frac{P ( H1 )}{1 - P ( H1 )}$$

consists in determining the probability of sending of signals on the RACH channel listened to by the receiver system. To do this, we determine the number A of bursts detected on the RACH channel in an observation period T_{obs} (“number of RACHs” in step 12 of FIG. 2) as well as the theoretical maximum number T of bursts that can be transmitted on the RACH channel (“max number of RACHs” in step 13 of FIG. 2) in the same period.

The number A of bursts detected on the RACH channel during T_{obs} can easily be ascertained by the receiver system since this is what decides regarding the detection or otherwise of such bursts. It therefore suffices for it to count each detection during the observation period.

The maximum number T of bursts that can be transmitted on the RACH channel during T_{obs}, can be calculated by the receiver system as a function of the time interval Tᵢ separating the sending of two bursts and the number J of possible predetermined sequences for the RACH or sequences used by the relevant base station (typically J=16). In UMTS, Tᵢ=5120 chips=1.33 ms. In GSM, Tᵢ=148 bits=0.58 ms. The number T is given by T=J×T_{obs}/Ti.

According to the foregoing, P(H1) can be estimated over the period T_{obs} on the basis of the magnitudes A and T estimated, according to the formula P(H1)=A/T. The ratio P(H1)/P(H0) can then be written P(H1)/P(H0)=A/(T−A).

This ratio, updated in step 14 for each observation period T_{obs} , can advantageously be introduced into the detection criterion (1), so as to enhance the reliability of the detection of requests for access to the network on an RACH channel, by virtue of a posteriori consideration of the behaviour of the users asking for the RACH channel. Stated otherwise, the threshold c′ used is adjusted proportionally to (T−A)/A.

Another aspect of the invention comprises an estimation of the false detection rate for the burst over the observation period T_{obs}.

In accordance with the foregoing, the receiver system has available the maximum possible number T of random-access bursts that can be transmitted on the RACH channel during an observation period T_{obs}. It furthermore determines a number of erroneous detections of such a burst on the RACH channel, that is to say a number F of signals detected and interpreted wrongly by the receiver system as corresponding to requests for access to the network.

A request for access to the network by a terminal 1 in fact forms the subject of a specified exchange of signalling. It is therefore appropriate to verify whether this exchange has or has not proceeded correctly to completion, in order to ascertain whether the request for resources detected at the receiver system was real.

By way of illustration, FIG. 3 shows such an exchange of signalling in the context of the GSM radiocommunication system. The request for access to the network by the terminal 10 forms the subject of the “Channel_Request” up message on an RACH channel, incorporating the burst to be detected by the base station. On detection of this message, the base station 20 informs the BSC 30 of the request (“Channel_Required” message) . The BSC 30 then reserves communication resources which it indicates to the base station 20 (“Channel_Active” message), before receiving an acknowledgement in response (“Channel_Activate Ack” message). The BSC 30 then sends an “Immediate_Assignment” message to the terminal 10 by way of the base station 20 to indicate to it the communication resources that are assigned to it. Thereafter, a layer signalling exchange 3 is performed so as to confirm the opening of a communication path between the terminal 10 and the radio network (“SABME”, “UA” and “Estab_Indic” messages).

Thus, if the base station 20 does not receive, for example, the layer “SABME” message 3 after having transmitted the “Immediate_Assignment” resources allocation message, the receiver system can conclude therefrom that the network access request from the terminal 10 has been wrongly detected. On the other hand, if the signalling exchange confirms that the terminal 10 has indeed sent an access request, the receiver system will not count an erroneous detection.

It should be noted that a similar signalling exchange could make it possible to distinguish completed requests from the “false” requests for access to the network in other types of systems, such as for example in the UMTS system (“Universal Mobile Telecommunication System”) or any other equivalent system.

The receiver system, that is to say the base station 20 and/or the BSC 30, counts up the “false” requests during T_{obs}, and deduces therefrom the number F of erroneous detections on the RACH channel (or “number of false RACHs” in FIG. 2) over the observation period T_{obs} (step 15 in FIG. 2).

In step 16, it obtains the estimation of the false detection rate on the RACH channel (or “false RACH rate” in FIG. 2) defined as the ratio F/T of the number F of false RACHs to the maximum possible number T of RACHs over the observation period T_{obs}.

The latter ratio gives an indication of the reliability of the detection of the signals on the RACH channel. Specifically, if detection is reliable, the proportion of false RACHs detected by the receiver system will be low relative to all the signals detected during T_{obs}, in particular noise. Conversely, if the ratio F/T is high, this implies that numerous decisions of the receiver system, subsequent to the detection of a signal, have led wrongly to interpret noise as being a signal carried by the RACH.

The receiver system uses the ratio F/T to tailor the criterion for detecting signals on the RACH channel that it uses. In particular, the detection threshold level c or c′ may advantageously be modified as a function of this ratio F/T. For example, if F/T is too high (by comparison with an objective which may for example be of the order of 10⁻³), this implies that the detection of the burst is too sensitive and hence that the detection threshold should be hardened (increased). Conversely, if the ratio F/T is deemed to be too low by the receiver system, this implies that the detection tends to miss random-access bursts, and that the detection criterion should rather be relaxed, that is to say the threshold should be decreased.

In this way the network slaves the detection threshold c or c′ in order to attain an objective in terms of false detection rate F/T.

The criterion thus tailored as a function of the probability ratio P(H1)/P(H0) and/or of the false detection rate F/T is applied by the base station (step 18 in FIG. 2) to the evaluations of the detection magnitude (for example of the form P(z/H1)/P(z/H0)) that were obtained in step 17.

In the foregoing, the base station 20 and the BSC 30 were regarded as a whole forming a receiver system. In reality, certain functions of the receiver system will be implemented by the base station 20 and others by the BSC 30.

In particular, the detection of bursts is customarily performed by the base station 20, while certain of the estimations of steps 12 to 16 may be performed by the BSC 30. In this case, the way in which to adapt the detection criterion used by the base station 20 can be indicated to the latter by the BSC 30. It may therefore for example indicate to it that the detection threshold c′ used by the base station should be increased or decreased by a certain value, for example by a number of increments or of decrements that it determines.

Likewise holds of course when the radiocommunication system used is UMTS. In this case, the RNC can dispatch such commands to the node B by way of the NBAP (“Node B Application Part”) signalling exchange protocol.

1. Method for detecting a signal burst transmitted on the initiative of a sender on a radio channel listened to by a receiver system, the transmitted burst representing a predetermined digital sequence, in which method channel parameters representing a statistical behaviour of the radio channel are estimated and a detection magnitude is evaluated on the basis of the estimated channel parameters and of a correlation between a signal received at the receiver system and the predetermined digital sequence, wherein the detection magnitude is compared with an adaptive detection threshold to decide whether the signal burst is detected.

2. Method according to claim 1, in which a false detection rate for the burst is estimated, over an observation period, and the adaptive detection threshold is varied as a function of the estimated false detection rate.

3. Method according to claim 2, in which the estimation of the false detection rate for the burst comprises a countdown of a number of signalling procedures which begin with the detection of a burst during the observation period and which do not complete.

4. Method according to claim 1, in which, over an observation period, a ratio of a probability of transmission of the burst by a sender to a probability of absence of transmission of the burst is estimated.

5. Method according to claim 4, in which the estimation of the probability ratio comprises a countdown of the number of detections of the burst during the observation period.

6. Method according to claim 1, in which said estimated channel parameters comprise moments of order greater than 2 of the gain on the radio channel.

7. Method according to claim 6, in which said estimated channel parameters comprise moments of order 0 to k of the gain on the radio channel, where k is an integer larger than 2.

8. Method according to claim 6, in which the signal received is subjected to a filtering matched to the predetermined digital sequence so as to obtain said correlation in the form of a complex signal having a first component on an in-phase path and a second component on a quadrature path.

9. Method according to claim 8, in which the evaluated detection magnitude is proportional to
$$( {\sum }_{n = 0}^{k} \frac{1}{n ! {( \sqrt{{N}_{0}} )}^{n}} \cdot {H}_{n} ( \frac{{z}_{x}}{\sqrt{{N}_{0}}} ) \cdot m {a}_{x , n} ) \cdot ( {\sum }_{n = 0}^{k} \frac{1}{n ! {( \sqrt{{N}_{0}} )}^{n}} \cdot {H}_{n} ( \frac{{z}_{y}}{\sqrt{{N}_{0}}} ) \cdot m {a}_{y , n} ) ,$$
where N₀ denotes the estimated power of the noise on the radio channel, zₓ and z_{y} denote said first and second components, ma_{x,n} and ma_{y,n} denote the moments of order n of the gain on the in-phase path and on the quadrature path respectively, Hₙ denotes the Hermite polynomial of order n and k is an integer larger than 2.

10. Method according to claim 1, in which said sender is a mobile terminal, said receiver system belongs to a radiocommunication network and in which said burst is sent so as to request access to the network.

11. Receiver system able to detect a signal burst transmitted on the initiative of a sender on a radio channel listened to by the receiver system, the transmitted burst representing a predetermined digital sequence, comprising means of estimating channel parameters representing a statistical behaviour of the radio channel, means of evaluating a detection magnitude from the estimated channel parameters and a correlation between a signal received at the receiver system and the predetermined digital sequence, means of comparing the detection magnitude with a detection threshold to decide whether the signal burst is detected, and means for adapting the detection threshold.

12. Receiver system according to claim 11, furthermore comprising means of estimating, over an observation period, a false detection rate for the burst, in which the adaptation means comprise means for varying the detection threshold as a function of the estimated false detection rate.

13. Receiver system according to claim 12, in which the means for estimating the false detection rate comprise countdown means for metering a number of signalling procedures which begin with the detection of a burst during the observation period and which do not complete.

14. Receiver system according to claim 11, furthermore comprising means of estimating, over an observation period, a ratio of a probability of transmission of the burst by a sender to a probability of absence of transmission of the burst.

15. Receiver system according to claim 14, in which the means for estimating the probability ratio comprise countdown means for metering the number of detections of the burst during the observation period.

16. Receiver system according claim 11, comprising at least one base station and a base station controller, in which the means for estimating channel parameters, the means for evaluating the detection magnitude and the means of comparison form part of the base station, while a part at least of the adaptation means forms part of the base station controller.

17. Receiver system according to claim 16, in which the base station controller comprises means for transmitting messages for adjusting the detection threshold to the base station.

18. Receiver system according to claim 11, in which said estimated channel parameters comprise moments of order greater than 2 of the gain on the radio channel.

19. Receiver system according to claim 18, in which said estimated channel parameters comprise moments of order 0 to k of the gain on the radio channel, where k is an integer larger than 2.

20. Receiver system according to claim 18, comprising means of filtering, matched to the predetermined digital sequence, to which the signal received is subjected to obtain said correlation in the form of a complex signal having a first component on an in-phase path and a second component on a quadrature path.

21. Receiver system according to claim 20, in which the evaluated detection magnitude is proportional to
$$( {\sum }_{n = 0}^{k} \frac{1}{n ! {( \sqrt{{N}_{0}} )}^{n}} \cdot {H}_{n} ( \frac{{z}_{x}}{\sqrt{{N}_{0}}} ) \cdot m {a}_{x , n} ) \cdot ( {\sum }_{n = 0}^{k} \frac{1}{n ! {( \sqrt{{N}_{0}} )}^{n}} \cdot {H}_{n} ( \frac{{z}_{y}}{\sqrt{{N}_{0}}} ) \cdot m {a}_{y , n} ) ,$$
where N₀ denotes the estimated power of the noise on the radio channel, zₓ and z_{y} denote said first and second components, ma_{x,n} and ma_{y,n} denote the moments of order n of the gain on the in-phase path and on the quadrature path respectively, Hₙ denotes the Hermite polynomial of order n and k is an integer larger than 2.

22. Receiver system according to claim 11, in which said sender is a mobile terminal, said receiver system belongs to a radiocommunication network and in which said burst is sent so as to request access to the network.
